(19) United States
(12) Patent Application Publication
(10) Pub. No.: US 2005/0084230 A1
(43) Pub. Date: Apr. 21, 2005

(54) Polymers based on CTFE/VCA/HFP or TFE/VCA/HFP

(76) Inventors: Thierry Pascal, Charly (FR); Bernard Boutevin, Montpellier (FR); Georges Kostov, Montpellier (FR); Alain Rousseau, Montpellier (FR); Jerome Alric, Lyon (FR); Jerome Fournier, Lyon (FR)

Correspondence Address: Thomas F. Roland, Esq.;Atofina Chemicals, Inc., 26th Floor, 2000 Market Street, Philadelphia, PA, 19103, US

(21) Appl. No.: 10/847,963

(22) Filed: May 18, 2004

(30) Foreign Application Priority Data
May 19, 2003 (FR) 03.05947

(51) Int. Cl. G02B 6/00

(52) U.S. Cl. 385/147

(57) ABSTRACT

A subject-matter of the invention is a copolymer comprising at least 3 units, P1, P2 and P3, with the following general formulae: 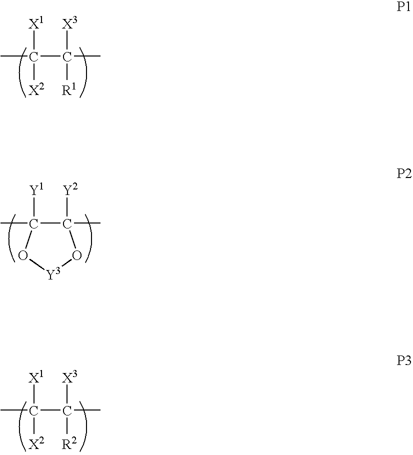
with X¹, X² and X³, which are identical or different, taken from the group of atoms consisting of H, F, Cl and Br;
with R¹ taken from the group of atoms consisting of H, F, Cl and Br;
with R² a carbonaceous group comprising from 1 to 10 partially or completely fluorinated carbon atoms;
with Y¹ and Y², which are identical or different, taken either from the group of atoms consisting of H, F, Cl and Br or from the family of the carbonaceous groups comprising from 1 to 10 carbon atoms;
with Y³ a carbonyl group or a divalent carbonaceous group;
the content of P2 unit in the copolymer being between 30 and 70 mol % for respectively a content of P1 and P3 units in the copolymer of between 70 and 30 mol % and the weight-average molar mass (Mw) of the said copolymer being between 10³ and 10⁶ g/mol. Preferably, the copolymer is of CTFE/VCA/HFP or TFE/VCA/HFP type.

This application claims benefit, under U.S.C. § 119(a) of French National Application Number 03.05947, filed May 19, 2003.

### FIELD OF THE INVENTION

The subject-matter of the present invention is an oligomer which is a copolymer which makes possible the preparation of formulations which can be used for the manufacture of transparent objects exhibiting a glass transition temperature of greater than 60° C., it being possible for these objects in particular to act as guide or conductor for light with wavelengths of visible or near infrared type. The invention also relates to the processes for the synthesis of the abovementioned oligomer.

Advantageously, the copolymer which is a subject-matter of the invention is a terpolymer resulting from the copolymerization:
of vinylene carbonate (VCA),
of hexafluoropropene (HFP), and
of chlorotrifluoroethylene (CTFE) or of tetrafluoroethylene (TFE).

### BACKGROUND OF THE INVENTION

It is of great interest to design a polymer material having the properties necessary for preparing optical fibres. Reference may be made, to this end, to the article “Polymeric Materials for Devices in Optical Fibre Systems” by Anthony R. Blythe and John R. Vinson (Polymers for Advanced Technologies, Vol. 11, pages 601-611, 2000).

Perfluorinated amorphous polymers, derived from perfluorinated cyclic monomers, exhibiting glass transition temperatures of greater than 100° C. are already known in the manufacture of optical fibres. However, the synthesis of these perfluorinated cyclic monomers is difficult and lengthy (several synthetic stages). It requires the use of dangerous fluorinating agents, which limits their accessibility and leads to very high cost prices for the polymer (see “TEFLON® AF Amorphous Fluoropolymers”, Paul R. Resnick and Warren H. Buck, Modern Fluoropolymers, pages 397-398, edited by John Scheires, 1997, John Wiley & Sons Ltd).

Moreover, these fluorinated polymers are difficult to dissolve in the usual solvents, which implies the use of fluorinated solvents, with the disadvantages which that represents.

Polymers with the repeat entity —(CF₂—CFX)— in which X═F, Cl or Br have a glass transition temperature (Tg), the temperature above which limited movements of the polymer chains are possible, which is not very high. Their Tg is close to ambient temperature, which does not make it possible to ensure complete stability of the optical properties under the thermal or climatic conditions of use of the materials.

A random copolymer resulting from the copolymerization of chlorotrifluoroethylene (CTFE) and vinylene carbonate (VCA) with a molecular mass (Mn) of 2000 is also known in the literature (M. Krebs and C. Schneider, Adv. Chem. Ser., Vol. 142, pages 92-98, 1975), which copolymer exists in the form of a white solid incompatible with an optical application.

The fluorinated polymers developed to date involve monomers or oligomers which are difficult to access, either because of the number of stages necessary for their synthesis or because of the danger generated by the use of fluorinating agents or because of their cost. Furthermore, the derived fluorinated materials exhibit an inadequate thermomechanical behaviour.

It is therefore seen that no fluorinated or partially fluorinated polymer developed to date is fully satisfactory. Furthermore, it is particularly important in the field of optical fibres to have available a polymer which exhibits very good miscibility in a diluent or diluent mixture, making it possible to obtain a transparent material on conclusion of the spinning process defined in the document U.S. Pat. No. 6,428,893 or U.S. Pat No. 6,576,166. The said diluent which can be used for the spinning process is a compound comprising at least one photoreactive functional group chosen from the group formed by alkyl (meth)acrylates and vinyl compounds.

### BRIEF DESCRIPTION OF THE FIGURES

FIG. 1 diagrammatically represents a device which makes possible the manufacture of a plastic optical fibre from the copolymers according to the present invention.

FIG. 2 shows the attenuation spectra of a graded index plastic optical fibre obtained from processes of the prior art and from a process according to one of the methods of preparation of plastic optical fibre from the copolymers according to the invention.

### DESCRIPTION OF THE INVENTION

As regards the alkyl (meth)acrylates, mention may be made:
broadly, of fluorinated (meth)acrylates and more particularly of α-fluoroacrylates, α, β-difluoroacrylates and acrylic derivatives of fluorinated alcohols and diols. Mention may preferably be made of trifluoroethyl acrylate (abbreviation TRIFEA) and perfluorohexanediol diacrylate.
of hydrogenated (meth)acrylates, such as hexanediol diacrylate (HDDA), cyclohexanedimethanol diacrylate, tricyclodecanedimethanol diacrylate (TCDDMDA), trimethylolpropane triacrylate (TMPTA) and its ethoxylated derivative (EtOTMPTA), pentaerythritol tetraacrylate (PETA), ditrimethylolpropane tetraacrylate (di-TMPTA), diacrylate derivatives of ethylene glycol (PEGDA), of neopentyl glycol (NPGDA) and of propylene glycol (DPGDA and TPGDA), and triacrylate derivatives of glycerol (GPTA).

As regards the vinyl compounds, mention may be made of vinyl ether derivatives and N-vinyl derivatives optionally comprising a partially chlorinated or fluorinated group. Maleimide derivatives, such as N-phenylmaleimide, can be added to this group.

A copolymer which is colourless and transparent in solution, which is soluble in the usual solvents (acetone, THF, ethyl acetate, inter alia), which has a glass transition temperature of greater than 60° C. and which is obtained from industrial * [symbol] monomers, these fluorinated monomers advantageously being chlorotrifluoroethylene, tetrafluoroethylene and hexafluoroethylene, and from an ethylene carbonate or from an ethylene acetal, advantageously vinylene carbonate, a readily accessible nonhalogenated monomer, has now been found by the Applicant Company. This copolymer exhibits the optical and thermomechanical properties required for applications such as:
the manufacture of light-conducting articles, for example optical fibres;
the manufacture of coatings or films, for example antireflection coatings or films, or;
the manufacture of photomasks.

This copolymer also exhibits the advantage of being soluble in reactive solvents, making possible the preparation of transparent formulations compatible with a process for the manufacture of optical fibres by spinning.

A subject-matter of the invention is a copolymer comprising at least 3 units, P1, P2 and P3, with the following general formulae: 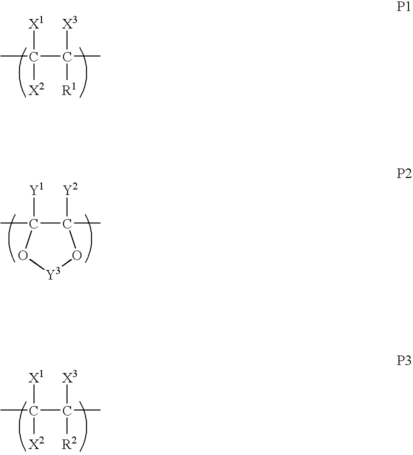
with X¹, X² and X³, which are identical or different, taken from the group of atoms consisting of H, F, Cl and Br;
with R¹ taken from the group of atoms consisting of H, F, Cl and Br;
with R² a carbonaceous group comprising from 1 to 10 partially or completely fluorinated carbon atoms;
with Y¹ and Y², which are identical or different, taken either from the group of atoms consisting of H, F, Cl and Br or from the family of the carbonaceous groups comprising from 1 to 10 carbon atoms;
with Y³ a carbonyl group or a divalent carbonaceous group;
the content of P2 unit in the copolymer being between 30 and 70 mol % for respectively a content of P1 and P3 units in the copolymer of between 70 and 30 mol % and the weight-average molar mass (Mw) of the said copolymer being between 10³ and 10⁶ g/mol.

According to one embodiment, the said content of P1 and P3 units is such that it comprises from 99 to 30 mol % of P1 units with R¹ an F or Cl atom per 1 to 70 mol % of P3 units with R² a CF₃ group.

According to one embodiment, the said content of P1 and P3 units is such that it comprises from 95 to 50 mol % of P1 units with R¹ an F or Cl atom per 5 to 50 mol % of P3 units with R² a CF₃ group.

According to one embodiment, the copolymer is characterized in that X¹═X²═X³═F.

According to one embodiment, the copolymer is characterized in that Y¹ and Y² are H atoms and Y³ is a carbonyl group.

According to one embodiment, the copolymer is characterized in that the weight-average molar mass (Mw) of the said copolymer is between 2×10³ and 5×10⁴ g/mol.

The invention also relates to an object comprising a copolymer as described above.

Another subject-matter of the invention is the use of copolymers as described above in the manufacture of light-conducting objects, of coatings, of films or of photomasks.

The invention is additionally directed towards a process for the synthesis of copolymers described above, characterized in that:
(a) the monomer M2 with the formula below, with Y¹ and Y², which are identical or different, taken either from the group of atoms consisting of H, F, Cl and Br or from the family of the carbonaceous groups comprising from 1 to 10 carbon atoms and with Y³ a carbonyl group or a divalent carbonaceous group, the level of M2 monomers reacted being between 30 and 70 mol % with respect to the total of the monomers reacted, is reacted, under an inert atmosphere, with
(b) a mixture of monomers M1 and M3 with the formulae below,
with X¹, X² and X³, which are identical or different, taken from the group of atoms consisting of H, F, Cl and Br,
with R¹ taken from the group consisting of H, F, Cl and Br,
with R² a carbonaceous group comprising from 1 to 10 partially or completely fluorinated carbon atoms,
the said mixture comprising 99 to 30 mol % of M1 monomers with respect to the total of the M1 and M3 monomers and from 1 to 70 mol % of M3 monomers with respect to the total of the M1 and M3 monomers; in the presence 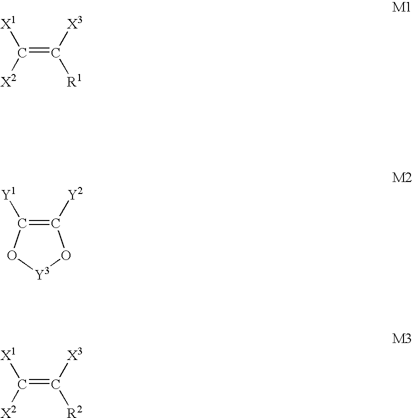
(c) of a polymerization initiator.

According to one embodiment, the process is characterized in that the temperature of the synthesis reaction is situated between 40 and 120° C.

According to one embodiment, the process is characterized in that the synthesis reaction takes place at a pressure situated between 5 and 20 bar.

According to one embodiment, the process is characterized in that the polymerization initiator is tert-butyl perpivalate.

The copolymer according to the invention comprises the P1, P2 and P3 units represented below.

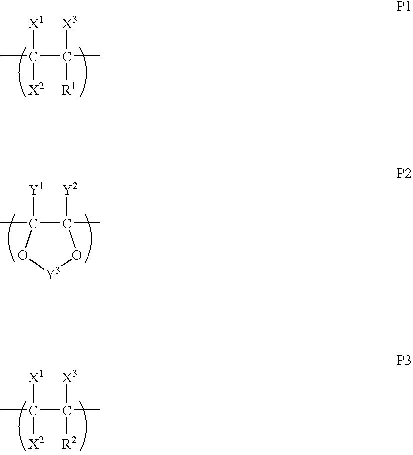

The copolymer according to the invention comprises one or more P1 units, one or more P2 units and one or more P3 units.

The monomer M1 which gives rise to the P1 units is a monomer taken from the group of the completely or partially fluorinated or then chlorofluorinated monomers with the general formula represented below: 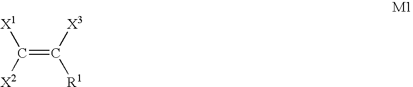
with X¹, X² and X³ identical or different atoms taken from the group consisting of H, F, Cl and Br, preferably F, and with R¹ an atom taken from the group consisting of H, F, Cl and Br, preferably F.

Preferably, the perfluorinated or chlorofluorinated monomers M1 will be chosen and more particularly tetrafluoroethylene (abbreviation TFE), with X¹═X²═X³═R¹═F, and chlorotrifluoroethylene (abbreviation CTFE), with X¹═X²═X³═F and R¹═Cl.

The monomer M3 which gives rise to the P3 units is a monomer taken from the group of the completely or partially fluorinated or then chlorofluorinated monomers with the general formula represented below: 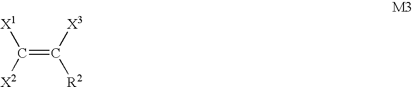
with X¹, X² and X³ identical or different atoms taken from the group consisting of H, F, Cl and Br, preferably F, and with R² a carbonaceous group comprising from 1 to 10 partially of completely fluorinated carbon atoms, preferably CF₃.

Preferably, the perfluorinated or chlorofluorinated monomers M3 will be chosen and more particularly hexafluoropropylene (abbreviation HFP), with X¹═X²═X³═F and R²═CF₃.

The monomer M2 which gives rise to the P2 units is a monomer with a cyclic structure of following general formula: 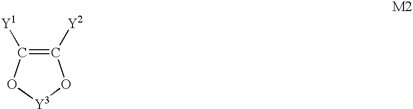
with Y¹ and Y², which are identical or different, taken either from the group of atoms consisting of H, F, Cl and Br or from the family of the carbonaceous groups comprising from 1 to 10 carbon atoms. Mention may be made, by way of examples, of the compounds for which Y¹═Y²═F, for which Y¹═H and Y²═Cl, for which Y¹═H and Y²═F, for which Y¹═H and Y²═H and for which Y¹═Cl and Y²═Cl, with Y³ either a carbonyl group or a divalent carbonaceous group.

Preferably, the monomer M2 is vinylene carbonate (abbreviation VCA) in which Y³ is a carbonyl group and Y¹ and y² are hydrogen atoms.

Use may be made, as process which makes it possible to obtain the copolymer, of any polymerization process known to a person skilled in the art which uses an organic solvent medium or a dispersion in an aqueous phase, for example in suspension or in emulsion. It will generally be preferable to operate in a solvent medium in order to promote intimate mixing of the various monomers.

Mention may be made, among solvents commonly used, of ethyl, methyl or butyl acetate or chlorofluorinated solvents, such as F141b® (CFCl₂—CH₃) or F113® (CF₂Cl—CFCl₂).

Use may be made, as polymerization initiator, of free radical generators, such as peroxide, hydroperoxide or percarbonate derivatives or azo compounds, such as azoisobutyronitrile (AIBN). Use may also be made, in the case of processes carried out in an aqueous medium, of inorganic free radical generators, such as persulphates or “redox” combinations.

The polymerization temperature is generally dictated by the rate of decomposition of the initiator system chosen and is generally situated between 0 and 200° C., preferably between 40 and 120° C.

The pressure is generally between atmospheric pressure and a pressure of 100 bar, more particularly between 2 bar and 20 bar.

In order to exert better control over the composition or the molar mass of the polymer, it is also possible to introduce, in all or in part, the monomers and the polymerization initiator continuously or portionwise during the polymerization.

The polymer according to the invention has a glass transition temperature (Tg) situated between 60 and 160° C., preferably between 80 and 140° C. This glass transition temperature is mainly related to the content of P2 units present in the copolymer. The transparency of the polymer obtained also depends on the content of P2 units.

The content of P2 units can vary in the copolymer as a function of the nature of R¹ of P1 and R² of P3. For R¹═F or Cl in P1 and R²═CF₃ in P3, the content of P2 units in the copolymer is between substantially 30 and 70 mol %. The content of P1 and P3 units is therefore between substantially 70 and 30 mol % in the copolymer.

In the case of the copolymerization of monomers M1=TFE and M3=HFP or M1═CTFE and M3═HFP, the content of HFP is between 1 and 70 mol % (preferably between 5 and 50 mol %) with respect to the total of the monomers M1 and M3 and the content of TFE or CTFE is between 99 and 30 mol % of monomers M1 with respect to the total of monomers M1 and M3.

The solubility of the copolymer in the reactive diluents is conditioned by its composition, and the copolymerization of monomers M1, M2 and M3 is advantageous with respect to the polymerization of a monomer M1 with a monomer M2 (in the absence of monomers M3) or of a monomer M3 with a monomer M2 (in the absence of monomers M1). Mention may be made of the combinations of monomers TFE/HFP/VCA and CTFE/HFP/VCA as particularly favourable for obtaining a high solubility, the latter property being demonstrated by the possibility of dissolving at least 40% by weight of copolymer in a broad mixing range of reactive diluents.

The solubility of the polymer in the reactive diluents also depends on its weight-average molar mass (Mw), which has to be between 10³ and 10⁶ g /mol and preferably between 2×10³ and 5×10⁴ g/mol.

The invention also relates to a graded index plastic optical fibre or a step index plastic optical fibre comprising a copolymer according to the invention, and to a process for the manufacture of such a fibre chosen from a process of UV type, a process of preform type and a process of coextrusion type.

The invention will now be illustrated by presenting nonlimiting examples of the implementation of the invention. Examples of CTFE/VCA/HFP terpolymers are presented here, but TFE/VCA/HFP terpolymers have also been prepared, leadiing to the same conclusions.

The reactants, initiators and solvents used are abbreviated:
CTFE: chlorotrifluoroethylene CF₂═CFCl
TFE: tetrafluoroethylene CF₂═CF₂
HFP: hexafluoropropylene
VCA: vinylene carbonate
TBPP: tert-butyl perpivalate, at 75% by mass in isododecane
EA: ethyl acetate
TRIFEA: trifluoroethyl acrylate
HDDA: hexanediol diacrylate
PEPC: 4-(1-propenyloxymethyl)-1,3-dioxolan-2-one
NVP: N-vinylpyrrolidone

The molar proportion of HFP with respect to the CTFE in the final polymer was determined by ¹⁹F NMR according to the relationship:

$$mol \% HFP / CTFE = I1 / ( I2 + I1 / 3 ) / 100$$

I1: area of the resonance of the CF₃ group of HFP
I2: area of the resonances of the CF₂ groups of HFP and of CTFE and of the CF group of CTFE

The Mw (weight-average molar mass) values are determined by SEC (steric exclusion chromatography) analysis. A Spectra Physic “Winner Station” device is used. Detection is carried out by refractive index. The column is a 5 micron mixed C PL gel column from Polymer Laboratory and the solvent used is THF with a flow rate of 0.8 ml/min. The weight-average molar masses (Mw) are expressed in g.mol⁻¹ in comparison with a polystyrene standard.

The Tg (glass transition temperature) values are determined by differential scanning calorimetry (DSC). A first temperature rise is carried out at 20° C. per minute, followed by cooling and then a second temperature rise, during which the Tg (glass transition temperature) values or the Tm (melting temperature) values are recorded. The temperature range is from 50° C. to 200° C. if the Tg is greater than 60° C.

### Comparative 1—Starting Composition: CTFE/VCA-40/60 Molar

The polymerization is carried out in a 1.2 litre autoclave made of stainless steel. 355 g of solution comprising 115 g (i.e. 1.33 mol) of VCA and 240 g (i.e. 2.73 mol) of EA are introduced into the reactor. The reactor is subsequently closed and purged three times with 20 bar of nitrogen. 105 g (i.e. 0.9 mol) of CTFE are introduced by suction into the reactor under vacuum. A solution comprising 3.88 g (i.e. 22.3 mmol) of TBPP initiator in 25 g (i.e. 0.284 mol) of EA is subsequently introduced using a pump. The reaction medium is heated at 85° C. for 3 hours with stirring with an initial pressure of approximately 8 bar.

At the end of the reaction, a solution of polymer in the EA with a solids content of 45% is obtained. 220 g of methanol are added to this solution. The polymer solution/methanol mixture is subsequently precipitated from 4 litres of ice-cold water. The precipitated polymer is filtered off and then dried in an oven at 50° C. for 48 h to constant weight.

203.5 g of dry polymer are thus isolated in the form of a white powder.

### EXAMPLE 2

### Starting Composition: CTFE/VCA/HFP-38.1/56.9/5 Molar

The polymerization is carried out in a 1.2 litre autoclave made of stainless steel. 311 g of solution comprising 105.5 g (i.e. 1.22 mol) of VCA and 206 g (i.e. 2.34 mol) of EA are introduced into the reactor. The reactor is subsequently closed and purged three times with 20 bar of nitrogen. 95 g (i.e. 0.82 mol) of CTFE are introduced by suction into the reactor under vacuum, followed by 16.2 g (i.e. 0.11 mol) of HFP. A solution comprising 3.75 g (i.e. 21.23 mmol) of TBPP initiator in 40.8 g (i.e. 0.463 mol) of EA is subsequently introduced using a pump. The reaction medium is heated at 85° C. for 3 hours with stirring with an initial pressure of approximately 8 bar.

At the end of the reaction, a solution of polymer in the EA with a solids content of approximately 45% is obtained. 207 g of methanol are added to this solution. The polymer solution/methanol mixture is subsequently precipitated from 4 litres of ice-cold water. The precipitated polymer is filtered off and then dried in an oven at 50° C. for 48 h to constant weight.

187.44 g of dry polymer are thus isolated in the from of a white powder.

### EXAMPLE 3

### Starting Composition: CTFE/VCA/HFP-37.3/55.7/7 Molar

The polymerization is carried out according to the same experimental protocol and with the same reactants as in Example 2.

The starting proportions of reactants are modified in order to increase the proportion of HFP in the final polymer while retaining a CTFE/VCA molar ratio of approximately ⅔. The molar proportion of initiator with respect to the sum of the monomers is kept constant and the amount of EA is adjusted so as to maintain a constant solids content in the vicinity of 45%.

The amounts of reactants and of solvent used are as follows:
VCA=105.5 g (1.22 mol)
CTFE=95 g (0.82 mol)
HFP=23 g (0.16 mol)
Total EA=269.4 g (227 g to dissolve the VCA and 42.4 g to dissolve the initiator)
TBPP=3.8 g (21.81 mmol).
   188.8 g of dry polymer are thus obtained in the form of a white powder.

### EXAMPLE 4

### Starting Composition: CTFE/VCA/HFP-35.7/53.3/11 Molar

The polymerization is carried out according to the same experimental protocol and with the same reactants as in Example 2.

The starting proportions of reactants are modified in order to increase the proportion of HFP in the final polymer while retaining a CTFE/VCA molar ratio of approximately ⅔. The molar proportion of initiator with respect to the sum of the monomers is kept constant and the amount of EA is adjusted so as to maintain a constant solids content in the vicinity of 45%.

The amounts of reactants and of solvent used are as follows:
VCA=94.35 g (1.09 mol)
CTFE=85 g (0.73 mol)
HFP=33.8 g (0.23 mol)
Total EA=256.5 g (217 g to dissolve the VCA and 39.5 g to dissolve the initiator)
TBPP=3.55 g (20.37 mmol).
   174.8 g of dry polymer are thus obtained in the form of a white powder.

### EXAMPLE 5

### Starting Composition: CTFE/VCA/HFP-32.1/47.9/20 Molar

The polymerization is carried out according to the same experimental protocol and with the same reactants as in Example 2.

The starting proportions of reactants are modified in order to increase the proportion of HFP in the final polymer while retaining a CTFE/VCA molar ratio of approximately ⅔. The molar proportion of initiator with respect to the sum of the monomers is kept constant and the amount of EA is adjusted so as to maintain a constant solids content in the vicinity of 45%.

The amounts of reactants and of solvent used are as follows:
VCA=83.25 g (0.96 mol)
CTFE=75 g (0.64 mol)
HFP=60.3 g (0.41 mol)
Total EA=264 g (224 g to dissolve the VCA and 40 g to dissolve the initiator)
TBPP=3.5 g (20.09 mmol).
   170.5 g of dry polymer are thus obtained in the form of a white powder.

The mol % of HFP with respect to CTFE in the oligomer obtained according to the procedure used in Examples 2, 3, 4 and 5 (abbreviated to Ex. 2-5) and Comparative 1 (Cp 1) described above, and the polymerization yield, the Tg (glass transition temperature), the Tm (melting temperature) and the weight-average molar mass are shown in TABLE 1.

TABLE 1

| | Proportion of | | | | |
|---|---|---|---|---|---|
| | HFP in the | | | | |
| | oligomer | | | | |
| | (mol % with | Polymerization | | | |
| | respect to | yield (% | Tg | Tm | Mw |
| | CTFE) | by weight) | (° C.) | (° C.) | (g/mol) |
| Cp 1 | 0 | 923 | 123 | No | 4600 |
| | | | | melting | |
| Ex. 2 | 2.1 | 87 | 120 | No | 5460 |
| | | | | melting | |
| Ex. 3 | 4.1 | 85 | 120 | No | 5500 |
| | | | | melting | |
| Ex. 4 | 4.8 | 82 | 122 | No | 5940 |
| | | | | melting | |
| Ex. 5 | 10.4 | 78 | 120 | No | 4950 |
| | | | | melting | |

The oligomers obtained in the above examples were dissolved in various mixtures of reactive diluent, at the rate of 1 equivalent by weight of oligomer per equivalent by weight of mixture of diluents.

The composition of the mixtures of reactive diluents and the results of the solubility tests are listed in TABLE 2. The tests of solubility in the reactive diluents are carried out at ambient temperature with stirring. The behaviour in solution is observed after 60 hours.

TABLE 2

| | Mixtures of reactive diluents | | | | | | | |
|---|---|---|---|---|---|---|---|---|
| | HDDA/TRIFEA | | NVP/TRIFEA | | | PEPC/TRIFEA | | |
| Proportions | 1/1 | 1/2 | 2/1 | 1/1 | 1/2 | 2/1 | 1/1 | 1/2 |
| Cp 1 | b | b | a | b | a | a | b | b |
| Ex. 2 | d | d | b | b | b | d | d | d |
| Ex. 3 | d | d | d | c | d | d | d | d |
| Ex. 4 | d | d | c | c | c | d | c-d | d |
| Ex. 5 | d | d | c | c | d | d | d | d |

The letters in TABLE 2 mean:
a = insoluble
b = soluble but cloudy
c = soluble and transparent at a % by weight of oligomer/diluent of 30/70
d = soluble and transparent

The manufacture of plastic optical fibre from the copolymers according to the invention described above will now be described.

According to a first type of process, referred to as the UV process and disclosed in detail in the document EP-1 067 222, which makes it possible to obtain a graded index optical fibre, that is to say for which the index varies continuously from the axis to the periphery of the fibre, once the copolymer C has been obtained, for example, according to one of the examples described above, two compositions C1 and C2 are prepared.

The two compositions C1 and C2 are different and each comprise a commercial photoinitiator, the copolymer of one of Examples 2 to 5 above and a reactive diluent composed of two monomers in different proportions according to the composition, the two monomers being D1 and D2.

The photoinitiator can, for example, be an α-hydroxyketone (Irgacure 184, Darocur 1173), a monoacylphosphine (Darocur TPO) or a bisacylphosphine (Irgacure 819).

D1 and D2 can be monomers having at least one acrylic, methacrylic, α-fluoroacrylic, α,β-difluoroacrylic or vinyl functional group comprising halogenated groups (fluorinated and chlorinated groups).

The constitution and the properties of the compositions C1 and C2, prepared from the mixture of copolymer of Example 5, the reactive diluent D1 being trifluoroethyl acrylate (the refractive index of which is equal to 1.342 at 20° C.) and the reactive diluent D2 being trifluoroethyl methacrylate (the refractive index of which is equal to 1.457 at 20° C.), are summarized in TABLE 3 below. The photoinitiator is of the category of the bisacylphosphines (BAPO, Irgacure 819). The amounts are calculated for 700 grams of composition.

TABLE 3

| | | | Amount of C |
|---|---|---|---|
| Composition | Amount of D1 (in g) | Amount of D2 (in g) | (in g) |
| C1 | 105 | 98 | 240 |
| C2 | 189 | 0 | 251 |

It is seen that the ratio, as % by weight, of the copolymer C to the sum of the constituents of each composition is constant, whereas, within the reactive diluent, the relative proportion, as % by weight, of D1 with respect to the sum of D1 and D2 varies from one composition to the other. This makes it possible to control the viscosity of the two compositions while varying the refractive index of each of these compositions.

Advantageously, to facilitate the use of the above compositions and the production of the fibre (miscibility of C, viscosity and reactivity of the resins, final mechanical properties of the material, and the like), it is possible to add an additional diluent D3, which is not involved in the adjusting of the refractive index, to each of the mixtures in TABLE 3. This diluent D3 is, for example and without implied limitation, a hydrogenated reactive diluent composed of 40% by weight of trimethylolpropane triacrylate (TMPTA) and of 60% by weight of propylene glycol 200 diacrylate (PEG-200 DA). For the two compositions C1 and C2 which appear above, the weight of D3 per 700 grams of composition is of the order of 260 g.

According to the process disclosed in the document EP-1 067 222 for preparing a graded index fibre, the continuous variation in index is created by preparing an active mixture of the two starting compositions C1 and C2. For this, the process is implemented with a mixing means which can be a mixer of static or dynamic type. This implementation is explained in detail in the document EP-1 067 222, which is incorporated here by way of reference. The operation of the static or dynamic mixer used in the process will therefore not be re-addressed here and this process will be described simply in its implementation using one of the static mixers disclosed in the document EP-1 067 222.

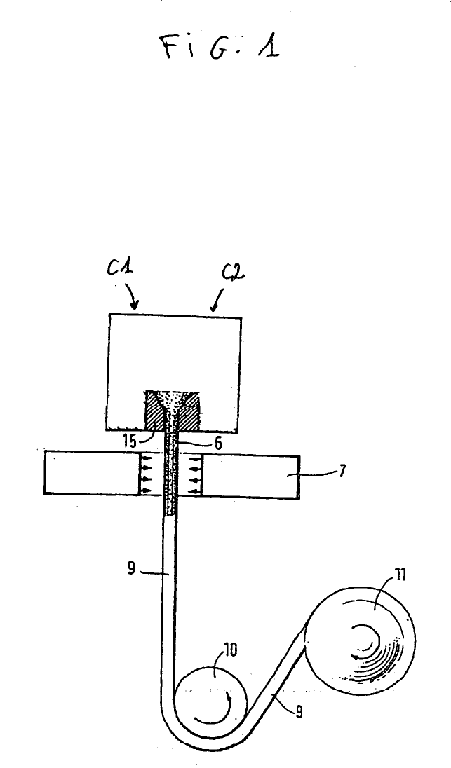

FIG. 1 represents a highly schematic sectional view, in a plane comprising a central axis X, of a device for the manufacture of an optical fibre according to the process of the invention.

The device 10 comprises a static mixer 1. The compositoins C1 and C2 in the above table are mixed therein.

The mixture thus obtained is conveyed to the die 15. This homothetic variation makes it possible to retain the form of the variation in concentration of the compositions C1 and C2.

At the outlet of the die 15, the yarn obtained, which is a graded index plastic optical fibre 6, is drawn via a capstan haul-off 10. According to one embodiment, the plastic optical fibre 6 is cured by photocrosslinking using a source 7 of ultraviolet (UV) radiation to give a polymerized plastic optical fibre 9. The plastic optical fibre 9 is then wound onto a spool 11 using the capstan haul-off 10. The diameter of the fibre 9 is given by the die 15 but it can be rendered finer according to the strength of the spinning carried out using the capstan haul-off 10. Either of the plastic optical fibres 6 or 9 can be used without distinction as finished product according to the invention.

The fibre thus obtained is thus a graded index fibre but the above process can also make it possible to obtain a step index fibre, that is to say for which the refractive index varies in a noncontinuous fashion between the axis of the fibre and the periphery. In this case, the active mixing of the compositions C1 and C2 is not carried out. C1 and C2 are then introduced into a distributor pot extended by a die, where the final diameter of the fibre and the proportion of core and of sheath are governed by the pressure and the temperature of the compositions C1 and C2 and by the diameter of the die.

The copolymers according to the invention also make it possible to obtain plastic optical fibres by other types of processes.

Thus, in order to manufacture a graded index plastic optical fibre, use may be made of a process such as that disclosed in the document U.S. Pat. No. 6,071,441, referred to as the preform process.

According to an implementational example, for the manufacture of the preform, 100 g of copolymer C of the CTFE/VCA/HFP copolymer type with a weight-average molar mass of greater than 10⁵ g/mol are melted at a temperature of between 200 and 250° C. in a cylindrical glass tube without filling it entirely, so that a vacant space is provided in the tube comprising the copolymer C before sealing the tube under vacuum. The glass tube is then placed in a horizontal position in an oven. It is subsequently subjected to a rotational movement about its horizontal axis (the speed of which is set at 2000 revolutions/minute) and the oven is brought to a temperature such that the viscosity of the molten copolymer C is between 10³ and 10⁵ poise, over three hours. The tube is subsequently cooled gradually over one hour. The tubular body thus obtained has an external diameter of 17 mm and an internal diameter of 5 mm, and its refractive index is 1.45.

A doping substance D is then introduced into the central part of this tubular body, still in the glass tube. Its proportion is . . . by weight with respect to the copolymer C. In order for the doping substance to be suitable for the material used, it is preferable for it to satisfy the following two conditions:
its refractive index n is greater than that of the copolymer C
the difference in the solubility parameters of the copolymer C and of the doping substance D is less than or equal to 7 (cal/cm³)^{1/2}.

Some examples of compounds which may be able to be used as doping substance D for this application are collated in the following Table 4.

TABLE 4

| Doping substance D | N | d (cal/cm³)^{1/2} |
|---|---|---|
| Benzyl n-butyl phthalate | 1.575 | 9.64 |
| 1-Methoxyphenyl-1- | 1.571 | 9.74 |
| phenylethane | | |
| Benzyl benzoate | 1.568 | 10.7 |
| Bromobenzene | 1.557 | 9.9 |
| o-Dichlorobenzene | 1.551 | 10.0 |
| m-Dichlorobenzene | 1.543 | 9.9 |
| 1,2-Dibromoethane | 1.538 | 10.4 |

The combination is again rotated in an oven. The doping substance D diffuses thermally through the molten copolymer C over 6 hours. Finally, the oven is gradually cooled at a rate of 15° C./hour to ambient temperature. A tubular body with an external diameter of 17 mm and an internal diameter of 4.5 mm is obtained with a graded refractive index profile.

This tubular body, constituting the preform of the graded index plastic optical fibre, is placed in a drawing furnace at a temperature of between 200 and 250° C. Its upper part is connected to a vacuum pump during the spinning stage. In this way, the preform is reduced in thickness and a graded refractive index optical fibre is recovered. Its dimensions depend on the rate of spinning, preferably between 5 and 10 m/min, and on the temperature of the furnace.

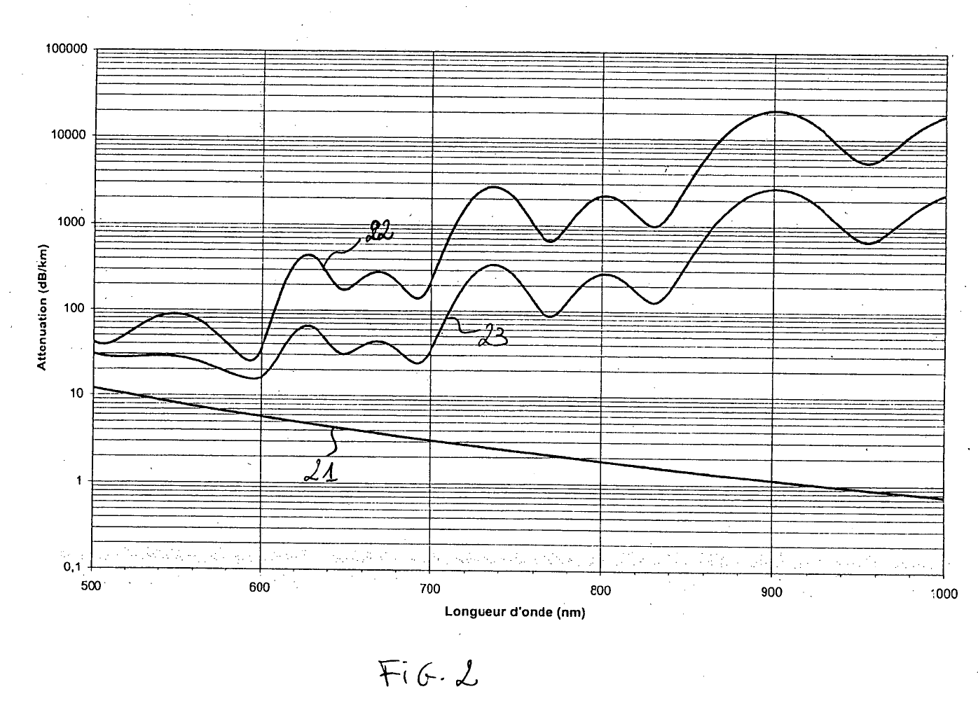

Advantageously, the use of copolymers C according to the invention, having a glass transition temperature greater than that of PMMA or of CYTOP, materials conventionally used in the known “preform” process, results in fibres having a transparency equivalent to or greater than those obtained with the conventional materials. This is illustrated in FIG. 2, where the attenuation (in dB/km) of a graded index plastic optical fibre, obtained, according to the process which has just been described, from CYTOP polymer of the prior art (curve 21), from PMMA polymer of the prior art (curve 22) and from CTFE/VCA/HFP (51/34/10) polymer according to the invention (curve 23), is represented as a function of the wavelength in nm.

In order to manufacture step index plastic optical fibres, it is possible to proceed, for example, by spinning a copolymer C according to the invention, for example obtained according to one of the above examples, in a molten state and simultaneous depositing a photocrosslinkable resin with a refractive index which is less than that of the copolymer C, this resin subsequently being photopolymerized. The thickness of the resin layer thus deposited is, for example, of the order of 100 μm.

Alternatively, it is possible, in order to manufacture a step index plastic optical fibre, to proceed by coextrusion of the copolymer C with a polymer with a refractive index which is less than of the copolymer C, such as, for example, PVDF, Teflon® AF from du Pont de Nemours or Hyflon AD® from Ausimont.

The last two processes mentioned are as such well known to a person skilled in the art and will not be described in more detail here.

Of course, the processes for the manufacture of plastic optical fibres mentioned above are not limited to the methods of preparation just described.

Thus, it is possible to use, as device for carrying out the UV process for the manufacture of graded index optical fibres, any device suitable for producing the active mixture and in particular, but not exclusively, those disclosed in the document EP-1 067 222.

In addition, the compositions and examples given are only given by way of indication and they can be modified without departing from the scope of the invention provided that the copolymer C retains the general characteristics mentioned above.

Finally, any means can be replaced by an equivalent means without departing from the scope of the invention.

1. Copolymer comprising at least 3 units, P1, P2 and P3, with the following general formulae: 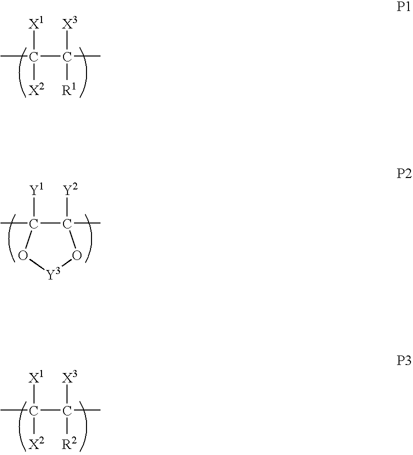
with X¹, X² and X³, which are identical or different, taken from the group of atoms consisting of H, F, Cl and Br;
with R¹ taken from the group of atoms consisting of H, F, Cl and Br;
with R² a carbonaceous group comprising from 1 to 10 partially or completely fluorinated carbon atoms;
with Y¹ and Y², which are identical or different, taken either from the group of atoms consisting of H, F, Cl and Br or from the family of the carbonaceous groups comprising from 1 to 10 carbon atoms;
with Y³ a carbonyl group or a divalent carbonaceous group;
the content of P2 unit in the copolymer being between 30 and 70 mol % for respectively a content of P1 and P3 units in the copolymer of between 70 and 30 mol % and the weight-average molar mass (Mw) of the said copolymer being between 10³ and 10⁶ g/mol.

2. Copolymer according to claim 1, characterized in that the said content of P1 and P3 units is such that it comprises from 99 to 30 mol % of P1 units with R¹ an F or Cl atom per 1 to 70 mol % of P3 units with R² a CF₃ group.

3. Copolymer according to claim 2, characterized in that the said content of P1 and P3 units is such that it comprises from 95 to 50 mol % of P1 units with R¹ an F or Cl atom per 5 to 50 mol % of P3 units with R² a CF₃ group.

4. Copolymer according to claim 1, characterized in that X¹═X²═X³═F.

5. Copolymer according to claim 1, characterized in that Y¹ and Y² are H atoms and Y³ is a carbonyl group.

6. Copolymer according to claim 1, characterized in that the weight-average molar mass (Mw) of the said copolymer is between 2×10³ and 5×10⁴ g/mol.

7. Object comprising a copolymer of claim 1.

8. The object according to claim 7 comprising a graded index plastic optical fibre.

9. The object according top claim 9 comprising a step index plastic optical fibre.

10. Use of the copolymer of claim 1 in the manufacture of light-conducting objects, of coatings, of films or of photomasks.

11 Process for the synthesis of the copolymer of claim 1, comprising reacting:
(a) the monomer M2 with the formula below, where Y¹ and Y², which are identical or different, are taken either from the group of atoms consisting of H, F, Cl and Br or from the family of the carbonaceous groups comprising from 1 to 10 carbon atoms and with Y³ a carbonyl group or a divalent carbonaceous group, the level of M2 monomers reacted being between 30 and 70 mol % with respect to the total of the monomers reacted, is reacted, under an inert atmosphere, with
(b) a mixture of monomers M1 and M3 with the formulae below,
with X¹, X² and X³, which are identical or different, taken from the group of atoms consisting of H, F, Cl and Br,
with R¹ taken from the group consisting of H, F, Cl and Br, and
with R² a carbonaceous group comprising from 1 to 10 partially or completely fluorinated carbon atoms,
the said mixture comprising 99 to 30 mol % of M1 monomers with respect to the total of the M1 and M3 monomers and from 1 to 70 mol % of M3 monomers with respect to the total of the M1 and M3 monomers; in the presence 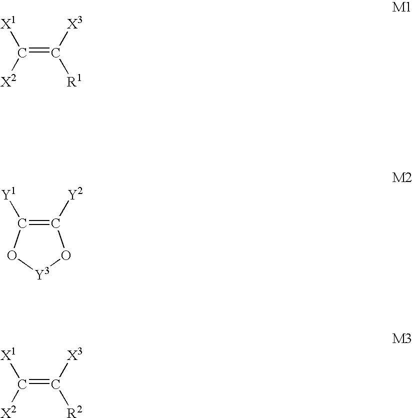
(c) a polymerization initiator.

12 Process according to claim 9, characterized in that the temperature of the synthesis reaction is situated between 40 and 120° C.

13. Process according to either of claim 11, characterized in that the synthesis reaction takes place at a pressure situated between 5 and 20 bar.

14. Process according to claim 11, characterized in that the polymerization initiator is tert-butyl perpivalate.

15. Process according to claim 11 used for the manufacture of a plastic optical fibre, characterized in that it is chosen from a process of UV type, a process of preform type and a process of coextrusion type.
